(19) United States
(12) Patent Application Publication
(10) Pub. No.: US 2021/0356694 A1
(43) Pub. Date: Nov. 18, 2021

(54) IMAGING OPTICAL SYSTEM, LENS UNIT, AND IMAGING DEVICE

(71) Applicants: Konica Minolta, Inc., Tokyo (JP); KONICA MINOLTA OPTO (DALIAN) CO., LTD., Dalian Economic & Technical Development (CN)

(72) Inventors: Atsushi YAMASHITA, Dalian Economic & Technical Development (CN); Hidekazu TOTSUKA, Tokyo (JP)

(21) Appl. No.: 17/318,069

(22) Filed: May 12, 2021

(30) Foreign Application Priority Data
May 13, 2020 (CN) 202010401921.4

(51) Int. Cl. G02B 9/12; H04N 5/225; G03B 17/12

(52) U.S. Cl. CPC G02B 9/12; G03B 17/12; H04N 5/2254

(57) ABSTRACT

An imaging optical system includes, in order from an object side: a meniscus first lens an object-side surface of which is convex and that has negative refractive power; a stop; a second lens that has positive refractive power; and a biconcave third lens. The imaging optical system satisfies Expression (1): 0.10<d12/f≤0.81 where d12 represents a spatial distance along an optical axis between the first lens and the second lens, and f represents a focal length of the entire imaging optical system.

### CROSS-REFERENCE TO RELATED APPLICATIONS

The entire disclosure of Chinese Patent Application No. 202010401921.4 filed on May 13, 2020 is incorporated herein by reference in its entirety.

### TECHNOLOGICAL FIELD

The present disclosure relates to an imaging optical system, a lens unit, and an imaging device.

### DESCRIPTION OF RELATED ART

A small imaging optical system has been developed for endoscopy and other usages. Such a small imaging optical system is required to have a wide angle of view and high image quality.

Optical systems disclosed in the Chinese patent application No. 108957729A and the Chinese patent application No. 108873311A, however, have a narrow angle of view of less than 90°. An optical system disclosed in the Chinese patent application No. 102768396A has a wide angle of view of 120° but has 40% distortion or greater, which may not yield a high quality image.

### SUMMARY

The present invention has been conceived in view of the above issues. Objects of the present invention include providing an optical system that has a wider angle of view than a known optical system and that appropriately corrects aberrations and that is short in overall length and easy to manufacture.

To achieve at least one of the abovementioned objects, according to an aspect of the present invention, an imaging optical system includes, in order from an object side:

a meniscus first lens an object-side surface of which is convex and that has negative refractive power;

a stop;

a second lens that has positive refractive power; and

a biconcave third lens, wherein

the imaging optical system satisfies Expression (1):

0.10<d12/f≤0.81

where d12 represents a spatial distance along an optical axis between the first lens and the second lens, and f represents a focal length of the entire imaging optical system.

To achieve at least one of the abovementioned objects, according to another aspect of the present invention, an imaging optical system includes, in order from an object side:

a meniscus first lens an object-side surface of which is convex and that has negative refractive power;

a stop;

a second lens that has positive refractive power; and

a biconcave third lens, wherein

the imaging optical system satisfies Expression (2):

1.0≤f1/f3≤2.6

where f1 represents a focal length of the first lens, and f3 represents a focal length of the third lens.

To achieve at least one of the abovementioned objects, according to another aspect of the present invention, an imaging optical system includes, in order from an object side:

a meniscus first lens an object-side surface of which is convex and that has negative refractive power;

a stop;

a second lens that has positive refractive power; and

a biconcave third lens, wherein

the imaging optical system satisfies Expression (3):

20<ν1<35

where ν1 represents an Abbe number of the first lens.

To achieve at least one of the abovementioned objects, according to another aspect of the present invention, an imaging optical system includes, in order from an object side:

a meniscus first lens an object-side surface of which is convex and that has negative refractive power;

a stop;

a second lens that has positive refractive power; and

a biconcave third lens, wherein

the imaging optical system satisfies Expression (4):

0.1≤d1/f≤0.4

where d1 represents a center thickness of the first lens, and f represents a focal length of the entire imaging optical system.

To achieve at least one of the abovementioned objects, according to another aspect of the present invention, an imaging optical system includes, in order from an object side:

a meniscus first lens an object-side surface of which is convex and that has negative refractive power;

a stop;

a second lens that has positive refractive power; and

a biconcave third lens, wherein

the imaging optical system satisfies Expression (5):

−2.1<f1/f≤−1.0

where f1 represents a focal length of the first lens, and f represents a focal length of the entire imaging optical system.

To achieve at least one of the abovementioned objects, according to another aspect of the present invention, an imaging optical system includes, in order from an object side:

a meniscus first lens an object-side surface of which is convex and that has negative refractive power;

a stop;

a second lens that has positive refractive power; and

a biconcave third lens, wherein

the imaging optical system satisfies Expression (6):

1.5<(r1+r2)/(r1−r2)<4.5

where r1 represents a radius of curvature of the object-side surface of the first lens, and r2 represents a radius of curvature of an image-side surface of the first lens.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a cross-sectional view of an imaging device in an embodiment;

FIG. 2 is a block diagram showing a schematic control system of the imaging device in the embodiment;

FIG. 3A is a cross-sectional view of an imaging optical system in a first example;

FIG. 3B shows longitudinal aberration diagrams of the imaging optical system in the first example;

FIG. 3C shows meridional lateral aberration diagrams of the imaging optical system in the first example;

FIG. 4A is a cross-sectional view of an imaging optical system in a second example;

FIG. 4B shows longitudinal aberration diagrams of the imaging optical system in the second example;

FIG. 4C shows meridional lateral aberration diagrams of the imaging optical system in the second example;

FIG. 5A is a cross-sectional view of an imaging optical system in a third example;

FIG. 5B shows longitudinal aberration diagrams of the imaging optical system in the third example;

FIG. 5C shows meridional lateral aberration diagrams of the imaging optical system in the third example;

FIG. 6A is a cross-sectional view of an imaging optical system in a fourth example;

FIG. 6B shows longitudinal aberration diagrams of the imaging optical system in the fourth example;

FIG. 6C shows meridional lateral aberration diagrams of the imaging optical system in the fourth example;

FIG. 7A is a cross-sectional view of an imaging optical system in a fifth example;

FIG. 7B shows longitudinal aberration diagrams of the imaging optical system in the fifth example;

FIG. 7C shows meridional lateral aberration diagrams of the imaging optical system in the fifth example;

FIG. 8A is a cross-sectional view of an imaging optical system in a sixth example;

FIG. 8B shows longitudinal aberration diagrams of the imaging optical system in the sixth example;

FIG. 8C shows meridional lateral aberration diagrams of the imaging optical system in the sixth example;

FIG. 9A is a cross-sectional view of an imaging optical system in a seventh example;

FIG. 9B shows longitudinal aberration diagrams of the imaging optical system in the seventh example; and

FIG. 9C shows meridional lateral aberration diagrams of the imaging optical system in the seventh example.

### DETAILED DESCRIPTION OF THE EMBODIMENTS

Hereinafter, an embodiment of the present invention is described with reference to the drawings. However, the scope of the present invention is not limited to the disclosed embodiment or examples.

FIG. 1 is a cross-sectional view of an imaging device 100 as an embodiment of the present invention.

As shown in FIG. 1, the imaging device 100 includes a camera module 30 for generating image signals.

The camera module 30 includes a lens unit 40 and a sensor 50. The lens unit 40 includes an imaging optical system 10. The sensor 50 converts a subject image formed by the imaging optical system 10 into image signals.

The lens unit 40 includes the wide-angle imaging optical system 10 and a lens barrel 41 that houses the imaging optical system 10.

The imaging optical system 10 includes an optical filter F, a first lens L1, a second lens L2, and a third lens L3. The detailed configuration of the imaging optical system 10 is described later.

The lens barrel 41 is formed of resin, metal, or glass fiber-containing resin. The lens barrel 41 houses and holds the imaging optical system 10 and other components. The lens barrel 41 formed of metal or glass fiber-containing resin is less heat-expandable than resin and therefore stably fastens the imaging optical system 10. The lens barrel 41 has an opening OP to let in light from the object side. The lens barrel 41 directly or indirectly holds the optical filter F and the first to third lens L1 to L3, which constitute the imaging optical system 10, and thereby determines the positions of the optical filter F and the lens L1 to L3 in the direction of an optical axis Ax of the imaging optical system 10 and in the direction orthogonal to the optical axis Ax.

The sensor 50 includes an imaging element(s) (solid-state imaging element) 51. The imaging element 51 detects the subject image formed by the imaging optical system 10 and performs photoelectric conversion.

The imaging element 51 is, for example, a CMOS image sensor. The imaging element 51 is positioned with respect to the optical axis Ax and fixed. The imaging element 51 has a photoelectric converter as an imaging surface I. Around the photoelectric converter, a signal processing circuit (not illustrated) is formed. The photoelectric converter has photoelectric conversion elements (i.e., pixels) arranged two-dimensionally. The imaging element 51 is not limited to the CMOS image sensor but may be other types of imaging elements, such as a CCD sensor.

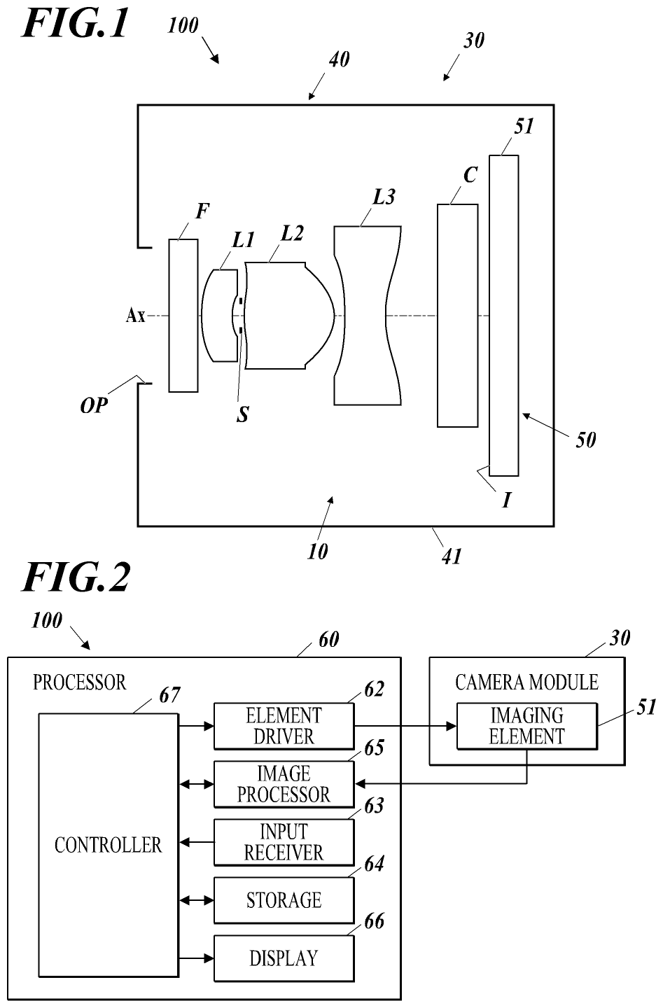

FIG. 2 is a block diagram showing a schematic control system of the imaging device 100.

As shown in FIG. 2, the imaging device 100 includes a processor 60 that operates the camera module 30.

The processor 60 includes an element driver 62, an input receiver 63, a storage 64, an image processor 65, a display 66, and a controller 67.

The element driver 62 receives, from the controller 67, voltage or clock signals for driving the imaging element 51 and outputs thereof to circuits connecting to the imaging element 51 to operate the imaging element 51.

The input receiver 63 receives operation performed by a user or commands from external devices.

The storage 64 stores information needed for operating the imaging device 100, image data obtained by the camera module 30, and lens correction data to be used for image processing.

The image processor 65 performs image processing on image signals output by the imaging element 51. The image processing includes color correction, gray level correction, and zooming.

The display 66 displays information, obtained images, and other information to be presented to the user. The display 66 may also have the function of the input receiver 63.

The controller 67 centrally controls operation of the element driver 62, the input receiver 63, the storage 64, the image processor 65, and the display 66 to perform various kinds of image processing on image data obtained by the camera module 30, for example.

Referring back to FIG. 1, the imaging optical system 10 is described in detail.

The imaging optical system 10 includes, in order from the object side, the optical filter F, the first lens L1, a stop (aperture stop) S, the second lens L2, the third lens L3, and a cover glass C.

The optical filter F in this embodiment is a parallel plate, such as an optical low-pass filter, an infrared cut-off filter (IR filter), or a seal glass of the imaging element 51. The optical filter F may be an individual filter, or the function of the optical filter F may be given to any of the surfaces of the lens constituting the imaging optical system 10. For example, an infrared cut-off court may be put on the surface(s) of one or more lenses.

The optical filter F is placed closer to the object than the first lens L1, so that an optical filter is not required between the third lens L3 as the rear lens and the imaging surface I. The back focus of the imaging optical system 10 can therefore be relatively shortened. This allows the lenses to be arranged with less difficulty based on their power and achieve relatively high optical performance. Further, sensitivity of each lens to manufacturing errors (degree of effect of manufacturing errors on optical performance) can be reduced.

The first lens L1 is a meniscus lens that has negative refractive power and the convex surface of which faces the object side.

The second lens L2 has positive refractive power.

The third lens L3 is biconcave.

The cover glass C is an image sensor cover that covers the imaging element 51.

Each of the first lens L1, the second lens L2, and the third lens L3 is a simple lens made of uniform material.

Such lenses L1 to L3 have more lens surfaces usable for correcting aberrations than compound lenses made by jointing different materials. Aberrations can therefore be corrected relatively easily to achieve high optical performance.

Preferably, the imaging optical system 10 satisfies the following Expression (1).

0.10<d12/f≤0.81 (1)

Herein, d12 represents the spatial distance along the optical axis Ax between the first lens L1 and the second lens L2, and f represents the focal length of the entire imaging optical system 10.

When d12/f is greater than the lower bound of Expression (1), the distance between the first lens L1 and the second lens L2 is not too short. This can reduce aberrations caused by excessive refractive power of the first and second lenses L1, L2 and variations of the optical performance caused by manufacturing errors of the first and second lenses L1, L2.

When d12/f is equal to or less than the upper bound of Expression (1), the distance between the first lens L1 and the second lens L2 is not too long. This allows the imaging optical system 10 to be smaller.

Further preferably, the imaging optical system 10 satisfies the following Expression (2).

1.0≤f1/f3≤2.6 (2)

Herein, f1 represents the focal length of the first lens L1, and f3 represents the focal length of the third lens L3.

When f1/f3 is equal to or greater than the lower bound of Expression (2), the refractive power of the first lens L1 is not too strong with respect to the refractive power of the third lens L3. When f1/f3 is equal to or less than the upper bound of Expression (2), the refractive power of the third lens L3 is not too strong with respect to the refractive power of the first lens L1. Accordingly, astigmatism, distortion, and lateral chromatic aberration can be corrected at the first and third lenses L1, L3 in a balanced manner.

Further preferably, the imaging optical system 10 satisfies the following Expression (3).

20<ν1<35 (3)

Herein, ν1 represents the Abbe number of the first lens L1.

When ν1 is greater than the lower bound of Expression (3), the chromatic dispersion of the first lens L1 is not too great. Accordingly, lateral chromatic aberration occurring at the first lens L1 is not too great in which short-wavelength light forms an image with a shortened height.

When ν1 is less than the upper bound of Expression (3), the chromatic dispersion of the first lens L1 is not too small. Accordingly, lateral chromatic aberration occurring at the first lens L1 is not too great in which short-wavelength light forms an image with a lengthened height.

Further preferably, the imaging optical system 10 satisfies the following Expression (4).

0.1≤d1/f≤0.4 (4)

Herein, d1 represents the center thickness of the first lens L1 along the optical axis Ax, and f represents the focal length of the entire imaging optical system 10.

When d1/f is equal to or greater than the lower bound of Expression (4), the first lens L1 is not too thin and has an appropriate distance between the object-side surface and the image-side surface. Accordingly, aberrations can be corrected at these surfaces of the first lens L1 in a balanced manner. Further, the first lens L1 has appropriate strength and is less likely to be distorted when fitted to the lens barrel 41.

When d1/f is equal to or less than the upper bound of Expression (4), the first lens L1 is not too thick. This allows the first lens L1 to maintain the refractive power relatively easily while keeping the same radius of curvature and refractive index. This also allows the distance between the stop S and the object-side surface of the first lens L1 can be relatively short, which allows the imaging optical system 10 to be smaller.

Further preferably, the imaging optical system 10 satisfies the following Expression (5).

−2.1<f1/f≤−1.0 (5)

Herein, f1 represents the focal length of the first lens L1, and f represents the focal length of the entire imaging optical system 10.

When f1/f is greater than the lower bound of Expression (5), the refractive power of the first lens L1 is not too great. This allows the imaging optical system 10 to have the reduced aberrations, such as distortion, astigmatism, and lateral chromatic aberration occurring at the first lens L1. This can also restrain decrease of the optical performance caused by form errors or eccentric errors of the first lens L1.

When f1/f is equal to or less than the upper bound of Expression (5), the refractive power of the first lens L1 is not too small. This can restrain the imaging optical system 10 from being large.

Further preferably, the imaging optical system 10 satisfies the following Expression (6).

1.5<(r1+r2)/(r1−r2)<4.5 (6)

Herein, r1 represents the radius of curvature of the object-side surface of the first lens L1, and r2 represents the radius of curvature of the image-side surface of the first lens L1.

When (r1+r2)/(r1−r2) is greater than the lower bound of Expression (6), the radius of curvature of the object-side surface of the first lens L1 is not too much greater than the radius of curvature of the image-side surface thereof, and the radius of curvature of the image-side surface of the first lens L1 is not too much smaller than the radius of curvature of the object-side surface thereof. Accordingly, the incidence angle of light is not too great at the object-side surface of the first lens L1, and the angle of refraction is not too great at the image-side surface of the first lens L1. This can reduce the aberrations occurring at these surfaces of the first lens L1.

When (r1+r2)/(r1−r2) is less than the upper bound of Expression (6), the radius of curvature of the object-side surface of the first lens L1 is not too close to the radius of curvature of the image-side surface thereof. This allows the first lens L1 to have sufficient negative refractive power for downsizing the imaging optical system 10 and for keeping the back focus.

The imaging optical system 10 may not satisfy all Expressions (1) to (6) but may satisfy at least one among Expressions (1) to (6).

Further preferably, the imaging optical system 10 satisfies the following Expression (7).

1.0≤f1/f3≤1.9 (7)

When f1/f3 is within the range of Expression (7), the advantageous effects achieved by satisfying Expression (2) can be further enhanced.

Further preferably, the imaging optical system 10 satisfies the following Expression (8).

−2.1≤f1/f≤1.55 (8)

When f1/f is within the range of Expression (8), the advantageous effects achieved by satisfying Expression (5) can be further enhanced.

Further preferably, the imaging optical system 10 satisfies the following Expression (9).

0.4<f2/f<0.7 (9)

Herein, f2 represents the focal length of the second lens L2.

When f2/f is greater than the lower bound of Expression (9), the refractive power of the second lens L2 is not too great. This allows the imaging optical system 10 to have the reduced aberrations, such as spherical aberration, coma aberration, and axial chromatic aberration occurring at the second lens L2. This can also restrain decrease of the optical performance caused by form errors or eccentric errors of the second lens L2.

When f2/f is less than the upper bound of Expression (9), the refractive power of the second lens L2 is not too small. This can restrain the imaging optical system 10 from being large.

Further preferably, the imaging optical system 10 satisfies the following Expression (10).

−1.5<f3/f<−0.6 (10)

Herein, f3 represents the focal length of the third lens L3.

When f3/f is greater than the lower bound of Expression (10), the refractive power of the third lens L3 is not too great. This allows the imaging optical system 10 to have the reduced aberrations, such as distortion, astigmatism, and lateral chromatic aberration occurring at the third lens L3. This can also restrain decrease of the optical performance caused by form errors or eccentric errors of the third lens L3.

When f3/f is less than the upper bound of Expression (10), the refractive power of the third lens L3 is not too small. This can restrain upsizing of the imaging optical system 10.

Further preferably, the imaging optical system 10 satisfies the following Expression (11).

0.3<(r3+r4)/(r3−r4)<0.7 (11)

Herein, r3 represents the radius of curvature of the object-side surface of the second lens L2, and r4 represents the radius of curvature of the image-side surface of the second lens L2.

By satisfying Expression (11), the imaging optical system 10 can have the reduced under-spherical aberration occurring at the second lens L2 to achieve high optical performance.

Further preferably, the imaging optical system 10 satisfies the following Expression (12).

0.2<(r5+r6)/(r5−r6)<0.8 (12)

Herein, r5 represents the radius of curvature of the object-side surface of the third lens L3, and r6 represents the radius of curvature of the image-side surface of the third lens L3.

When (r5+r6)/(r5−r6) is greater than the lower bound of Expression (12), the front principal point of the third lens L3 can be positioned close to the object, which allows the shorter distance between the principal points of the second lens L2 and the third lens L3. Accordingly, relatively weak refractive power of the third lens L3 can be achieved while keeping the same focal length f of the entire imaging optical system 10. It is therefore possible to reduce the aberrations occurring at the third lens L3 and variations of the optical performance caused by manufacturing errors.

When (r5+r6)/(r5−r6) is less than the upper bound of Expression (12), the refractive power of the third lens L3 is not too great. It is therefore possible to reduce the aberrations occurring at the third lens L3 and variations of the optical performance caused by manufacturing errors.

As described above, the imaging optical system 10 in this embodiment includes, in the order from the object side: the meniscus first lens L1 the convex surface of which faces the object side and that has negative refractive power; the stop S; the second lens L2 that has positive refractive power; and the biconcave third lens L3.

Using the minus first lens L1 allows the entrance pupil to be closer to the object than when the first lens L1 is a plus lens. This allows the wide-angle imaging optical system 10 to have a small front lens, which reduces the size of the imaging optical system 10.

Since the back focus can be relatively long with respect to the focal length, the imaging optical system 10 with a wide angle of view and a short focal length can have a space for housing optical elements, such as the optical filter F and cover glass C.

Since the first and third lenses L1, L3 have the refractive power of the same sign and are placed symmetrically about the stop S inbetween, the various types of aberrations, in particular distortion and lateral chromatic aberration, can be appropriately corrected.

The convex surface of the meniscus first lens L1 faces the object side. This allows the incident angle of light to be small at the object-side surface of the first lens L, which results in the reduced aberrations occurring at the object-side surface of the first lens L1. This also allows the back principal point of the meniscus first lens L1 to be closer to the image than when the first lens L1 is biconcave, which allows the distance between the principal points of the first and second lenses L1, L2 to be shorter. Accordingly, relatively weak refractive power of the first lens L1 can be achieved while keeping the same focal length f of the entire imaging optical system 10. It is therefore possible to reduce the aberrations occurring at the first lens L1 and variations of the optical performance due to manufacturing errors.

Since the third lens L3 is biconcave, the third lens L3 as a whole can have relatively strong negative refractive power. This allows the imaging optical system 10 to have a long back focus and have a space for housing optical elements, such as the optical filter F and the cover glass C. Moreover, the biconcave third lens L3 can have negative refractive power at the object-side and image-side surfaces in a balanced manner. It is therefore possible to reduce the aberrations occurring at the third lens L3 and variations of the optical performance caused by manufacturing errors.

Accordingly, the optical system having a wider angle of view than a known optical system can appropriately correct aberrations, while being small as a whole and easy to manufacture.

Further, by satisfying Expression (1), the imaging optical system 10 can have the reduced aberrations occurring at the first and second lenses L1, L2 and variations of the optical performance caused by manufacturing errors of the lenses L1, L2.

Further, by satisfying Expression (2), the imaging optical system 10 can correct astigmatism, distortion, lateral chromatic aberration, and other aberrations at the first lens L1 and the third lens L3 in a balanced manner.

Further, by satisfying Expression (3), the imaging optical system 10 can have the reduced lateral chromatic aberration that occurs at the first lens L1 and that causes short wavelength light to form an image with a shortened/lengthened height.

Further, by satisfying Expression (4), the imaging optical system 10 can correct aberrations at the object-side and image-side surfaces of the first lens L1 in a balanced manner, while keeping appropriate strength of the first lens L1. Moreover, the refractive power of the first lens L1 with the same radius of curvature and refractive index can be maintained relatively easily. Moreover, the distance between the stop S and the object-side surface of the first lens L1 can be reduced, which allows the imaging optical system 10 to be small.

Further, by satisfying Expression (5), the imaging optical system 10 can have the reduced aberrations, such as distortion, astigmatism, and lateral chromatic aberration occurring at the first lens L1 and restrain decrease of optical performance caused by form errors or eccentric errors of the first lens L1. The refractive power of the first lens L1 is not too weak to avoid increase in size of the imaging optical system 10.

Further, by satisfying Expression (6), the imaging optical system 10 can relatively easily keep negative refractive power of the first lens L1, while having the reduced aberrations occurring at the object-side and image-side surfaces of the first lens L1. Sufficient negative refractive power of the first lens L1 allows the imaging optical system 10 to be small and to keep the back focus.

The embodiment of the present invention described above does not limit embodiments to which the present invention is applicable, and can be appropriately modified without departing from the scope of the present invention.

### EXAMPLES

Hereinafter, examples of the imaging optical system according to the present invention are described. Followings are reference signs used in the examples.

f: Focal length of the whole imaging optical system

F: F-number

2Y: Length of diagonal of imaging surface of solid-state imaging element

ω: Maximum half angle of view

R: Radius of curvature

D: Distance between surfaces along optical axis

Nd: Refractive index of lens material at line d

vd: Abbe number of lens material

In the lens surface data of each example, the surface number followed by “*” indicates that the surface is an aspheric surface. The form of the aspheric surface is expressed by the following formula 1, wherein the origin of the aspheric surface is the apex of the surface, the X axis is in the direction of the optical axis, and h is the height orthogonal to the optical axis.

$$X = \frac{{h}^{2} \text{/} R}{1 + \sqrt{1 - ( 1 + K ) {h}^{2} \text{/} {R}^{2}}} + Σ {A}_{i} {h}^{i} \qquad [ Formula 1 ]$$

Herein, Ai represents aspheric coefficient of degree I, R represents radius of curvature, and K represents conic constant.

### First Example

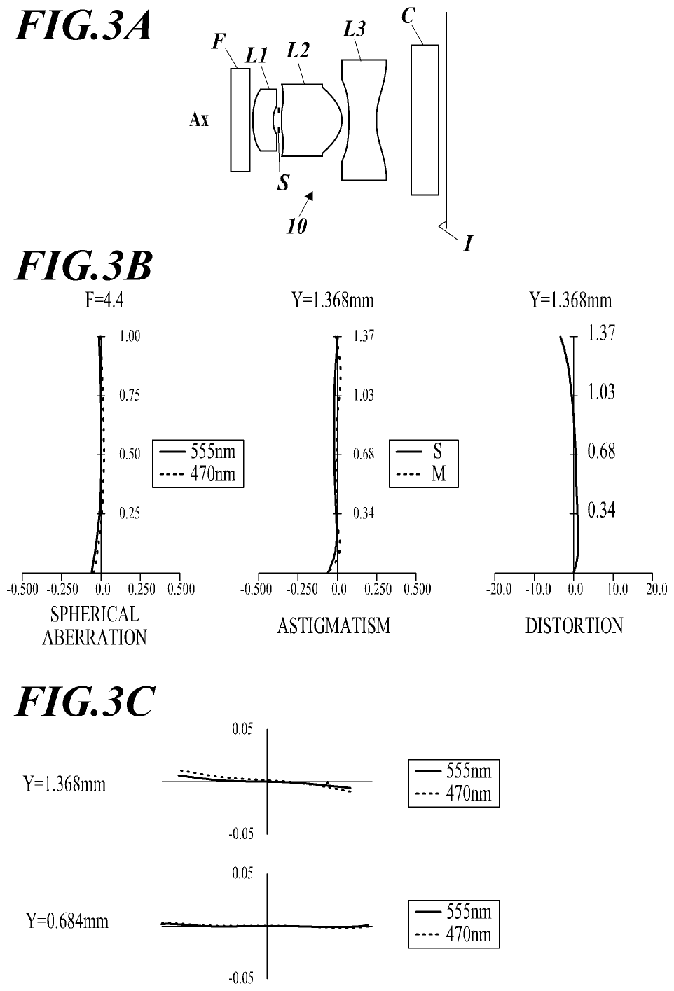

FIG. 3A is a cross-sectional view of an imaging optical system in a first example. FIG. 3B shows longitudinal aberration diagrams (spherical aberration, astigmatism, and distortion) of the first example. FIG. 3C shows meridional lateral aberration diagrams of the first example.

Followings are specifications of the imaging optical system in the first example.

f=1.232 mm

F=4.4

2Y=2.736 mm

2ω=90.7°

The following table 1 shows data of the lens surfaces in the first example.

TABLE 1

| Surface | | | | | Effective |
|---|---|---|---|---|---|
| number | R(mm) | D(mm) | Nd | ν d | radius(nm) |
| OBJ | ∞ | 10.0 | | | |
| 1 | ∞ | 0.30 | 1.5163 | 64.1 | 0.67 |
| 2 | ∞ | 0.03 | | | 0.52 |
| 3* | 1.257 | 0.31 | 1.6347 | 23.9 | 0.40 |
| 4* | 0.583 | 0.10 | | | 0.20 |
| 5(Stop) | ∞ | 0.01 | | | 0.15 |
| 6(Stop) | ∞ | 0.01 | | | 0.15 |
| 7* | 1.561 | 0.92 | 1.5434 | 56.1 | 0.18 |
| 8* | −0.325 | 0.10 | | | 0.48 |
| 9* | −1.455 | 0.43 | 1.6347 | 23.9 | 0.57 |
| 10* | 0.876 | 0.53 | | | 0.80 |
| 11 | ∞ | 0.41 | 1.5163 | 64.1 | 1.09 |
| 12 | ∞ | 0.12 | | | 1.27 |
| 13 | ∞ | | | | 1.37 |

The following table 2 shows aspheric coefficients of the lens surfaces in the first example. In the following description and tables of lens surface data, a power-of-ten number (e.g., 2.5×10−02) is expressed using E (e.g., 2.5E−02).

TABLE 2
3rd surface

| | |
|---|---|
| K = | −0.16783E+02 |
| A3 = | −0.73564E−01 |
| A4 = | 0.23040E+01 |
| A5 = | 0.70564E−01 |
| A6 = | −0.87196E+01 |
| A7 = | 0.00000E+00 |
| A8 = | 0.46268E+02 |
| A9 = | 0.00000E+00 |
| A10 = | 0.80603E+02 |
| A11 = | 0.00000E+00 |
| A12 = | −0.39131E+03 |
| A13 = | 0.00000E+00 |
| A14 = | −0.28109E+03 |
| A15 = | 0.00000E+00 |
| A16 = | 0.90243E+04 |
| A17 = | 0.00000E+00 |
| A18 = | 0.58603E+05 |
| A19 = | 0.00000E+00 |
| A20 = | −0.30245E+06 |

4th surface

| | |
|---|---|
| K = | −0.38279E+01 |
| A3 = | 0.11226E+00 |
| A4 = | 0.52258E+01 |
| A5 = | 0.98605E+01 |
| A6 = | −0.11035E+02 |
| A7 = | 0.00000E+00 |
| A8 = | −0.53030E+03 |
| A9 = | 0.00000E+00 |
| A10 = | 0.12487E+05 |
| A11 = | 0.00000E+00 |
| A12 = | 0.12026E+05 |
| A13 = | 0.00000E+00 |
| A14 = | −0.22445E+07 |
| A15 = | 0.00000E+00 |
| A16 = | 0.69016E+06 |
| A17 = | 0.00000E+00 |
| A18 = | 0.49878E+10 |
| A19 = | 0.00000E+00 |
| A20 = | −0.11471E+12 |

7th surface

| | |
|---|---|
| K = | 0.19020E+02 |
| A3 = | −0.54048E−01 |
| A4 = | 0.13058E+01 |
| A5 = | −0.17572E+01 |
| A6 = | −0.35704E+01 |
| A7 = | 0.00000E+00 |
| A8 = | 0.30767E+03 |
| A9 = | 0.00000E+00 |
| A10 = | −0.03314E+04 |
| A11 = | 0.00000E+00 |
| A12 = | −0.47256E+04 |
| A13 = | 0.00000E+00 |
| A14 = | 0.34869E+06 |
| A15 = | 0.00000E+00 |
| A16 = | 0.31692E+07 |
| A17 = | 0.00000E+00 |
| A18 = | −0.24810E+08 |
| A19 = | 0.00000E+00 |
| A20 = | −0.98246E+09 |

8th surface

| | |
|---|---|
| K = | −0.80449E+00 |
| A3 = | 0.57276E+00 |
| A4 = | 0.17637E+01 |
| A5 = | 0.25459E+00 |
| A6 = | −0.10514E+02 |
| A7 = | 0.00000E+00 |
| A8 = | 0.23080E+02 |
| A9 = | 0.00000E+00 |
| A10 = | 0.35217E+01 |
| A11 = | 0.00000E+00 |
| A12 = | 0.10801E+02 |
| A13 = | 0.00000E+00 |
| A14 = | 0.35855E+03 |
| A15 = | 0.00000E+00 |
| A15 = | −0.11118E+04 |
| A17 = | 0.00000E+00 |
| A18 = | −0.14853E+05 |
| A19 = | 0.00000E+00 |
| A20 = | 0.55416E+05 |

9th surface

| | |
|---|---|
| K = | −0.43737E+02 |
| A3 = | 0.42952E+00 |
| A4 = | −0.22184E+00 |
| A5 = | 0.43219E−01 |
| A6 = | −0.69126E+01 |
| A7 = | 0.00000E+00 |
| A8 = | 0.24584E+02 |
| A9 = | 0.00000E+00 |
| A10 = | −0.44420E+02 |
| A11 = | 0.00000E+00 |
| A12 = | 0.55167E+02 |
| A13 = | 0.00000E+00 |
| A14 = | −0.27396E+02 |
| A15 = | 0.00000E+00 |
| A16 = | −0.33595E+03 |
| A17 = | 0.00000E+00 |
| A18 = | 0.10201E+04 |
| A19 = | 0.00000E+00 |
| A20 = | −0.72846E+03 |

10th surface

| | |
|---|---|
| K = | −0.12157E+02 |
| A3 = | 0.21092E+00 |
| A4 = | −0.18799E+00 |
| A5 = | 0.30751E+00 |
| A6 = | −0.23741E+01 |
| A7 = | 0.00000E+00 |
| A8 = | 0.67389E+01 |
| A9 = | 0.00000E+00 |
| A10 = | −0.10314E+02 |
| A11 = | 0.00000E+00 |
| A12 = | 0.75973E+01 |
| A13 = | 0.00000E+00 |
| A14 = | −0.13725E+01 |
| A15 = | 0.00000E+00 |
| A16 = | 0.10962E+00 |
| A17 = | 0.00000E400 |
| A18 = | −0.22781E+01 |
| A19 = | 0.00000E+00 |
| A20 = | 0.15261E+01 |

Followings are numerical values of Expressions (1) to (6) and (9) to (12) in the imaging optical system of the first example.

d12/f=0.1 Expression (1):

f1/f3=2.60 Expression (2):

ν1=23.9 Expression (3):

d1/f=0.25 Expression (4):

f1/f=−1.69 Expression (5):

(r1+r2)/(r1−r2)=2.73 Expression (6):

f2/f=0.48 Expression (9):

f3/f=−0.65 Expression (10):

(r3+r4)/(r3−r4)=0.66 Expression (11):

(r5+r6)/(r5−r6)=0.25 Expression (12):

### Second Example

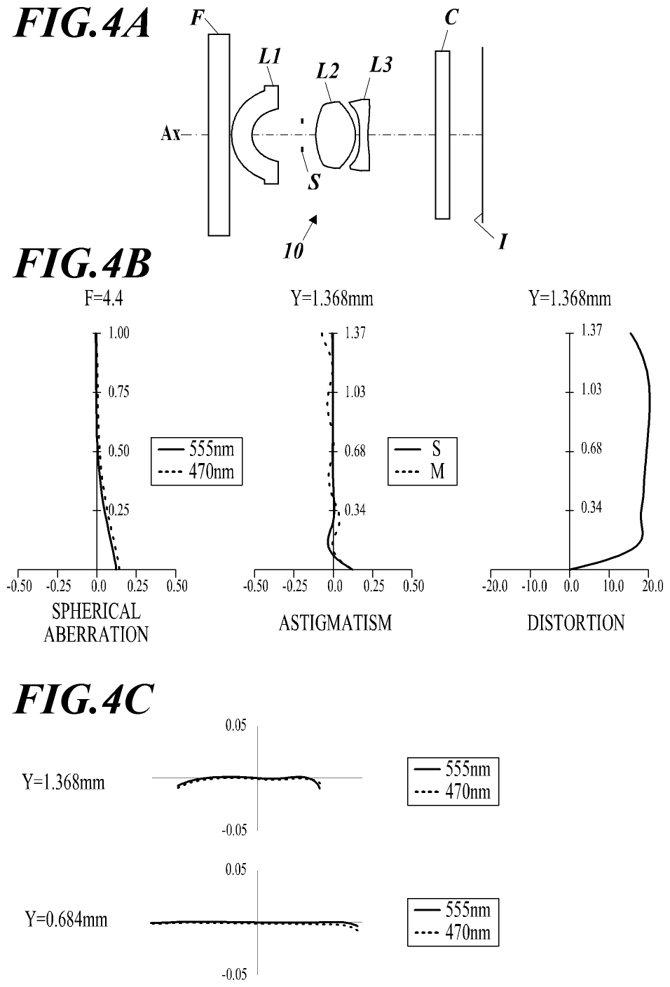

FIG. 4A is a cross-sectional view of an imaging optical system in a second example. FIG. 4B shows longitudinal aberration diagrams (spherical aberration, astigmatism, and distortion) of the second example. FIG. 4C shows meridional lateral aberration diagrams of the second example.

Followings are specifications of the imaging optical system in the second example.

f=1.14 mm

F=4.4

2Y=2.736 mm

2ω=92.0°

The following table 3 shows data of the lens surfaces in the second example.

TABLE 3

| Surface | | | | | Effetive |
|---|---|---|---|---|---|
| number | R(mm) | D(mm) | Nd | ν d | radius(mm) |
| 0BJ | ∞ | 10.0 | | | |
| 1 | ∞ | 0.30 | 1.5163 | 64.1 | 1.32 |
| 2 | ∞ | 0.03 | | | 1.16 |
| 3* | 0.743 | 0.29 | 1.6347 | 23.9 | 0.64 |
| 4* | 0.311 | 0.71 | | | 0.38 |
| 5(Stop) | ∞ | 0.02 | | | 018 |
| 6(Stop) | ∞ | 0.18 | | | 0.18 |
| 7* | 0.938 | 0.57 | 1.5434 | 56.1 | 0.37 |
| 8* | −0.435 | 0.06 | | | 0.43 |
| 9* | −1.877 | 0.12 | 1.6347 | 23.9 | 0.42 |
| 10* | 1.218 | 0.97 | | | 0.51 |
| 11 | ∞ | 0.20 | 1.5163 | 64.1 | 1.03 |
| 12 | ∞ | 0.47 | | | 1.10 |
| 13 | ∞ | | | | 1.37 |

The following table 4 shows aspheric coefficients of the lens surfaces in the second example.

TABLE 4
3rd surface

| | |
|---|---|
| K = | −0.50000E+02 |
| A3 = | 0.17773E+01 |
| A4 = | −0.46642E+00 |
| A5 = | 0.13562E+00 |
| A6 = | −0.82696E+01 |
| A7 = | 0.00000E+00 |
| A8 = | 0.42572E+02 |
| A9 = | 0.00000E+00 |
| A10 = | −0.67727E+02 |
| A11 = | 0.00000E+00 |
| A12 = | −0.27467E+02 |
| A13 = | 0.00000E+00 |
| A14 = | 0.16211E+03 |
| A15 = | 0.00000E+00 |
| A16 = | −0.22597E+03 |
| A17 = | 0.00000E+00 |
| A18 = | 0.12380E+04 |
| A19 = | 0.00000E+00 |
| A20 = | −0.20211E+04 |

4th surface

| | |
|---|---|
| K = | −0.58361E+00 |
| A3 = | −0.26289E+01 |
| A4 = | 0.18433E+02 |
| A5 = | −0.25377E+02 |
| A6 = | −0.57165E+02 |
| A7 = | 0.00000E+00 |
| A8 = | 0.90956E+02 |
| A9 = | 0.00000E+00 |
| A10 = | 0.94183E+04 |
| A11 = | 0.00000E+00 |
| A12 = | −0.36964E+05 |
| A13 = | 0.00000E+00 |
| A14 = | −0.54773E+06 |
| A15 = | 0.00000E+00 |
| A16 = | 0.33740E+07 |
| A17 = | 0.00000E+00 |
| A18 = | 0.95723E+07 |
| A19 = | 0.00000E+00 |
| A20 = | −0.65590E+08 |

7th surface

| | |
|---|---|
| K = | −0.42765E+01 |
| A3 = | 0.75764E−01 |
| A4 = | 0.23804E+00 |
| A5 = | −0.59809E+00 |
| A6 = | 0.94305E+01 |
| A7 = | 0.00000E+00 |
| A8 = | −0.14342E+03 |
| A9 = | 0.00000E+00 |
| A10 = | 0.11589E+04 |
| A11 = | 0.00000E+00 |
| A12 = | −0.53547E+04 |
| A13 = | 0.00000E+00 |
| A14 = | 0.88064E+04 |
| A15 = | 0.00000E+00 |
| A16 = | 0.13543E+06 |
| A17 = | 0.00000E+00 |
| A18 = | −0.13512E+07 |
| A19 = | 0.00000E+00 |
| A20 = | 0.38295E+07 |

8th surface

| | |
|---|---|
| K = | −0.65186E+00 |
| A3 = | 0.46234E+00 |
| A4 = | 0.13505E+01 |
| A5 = | 0.30905E+00 |
| A6 = | −0.95130E+01 |
| A7 = | 0.00000E+00 |
| A8 = | 0.21138E+02 |
| A9 = | 0.00000E+00 |
| A10 = | −0.25219E+02 |
| A11 = | 0.00000E+00 |
| A12 = | −0.13333E+03 |
| A13 = | 0.00000E+00 |
| A14 = | 0.50314E+03 |
| A15 = | 0.00000E+00 |
| A16 = | 0.27460E+04 |
| A17 = | 0.00000E+00 |
| A18 = | −0.23794E+04 |
| A19 = | 0.00000E+00 |
| A20 = | −0.45527E+04 |

9th surface

| | |
|---|---|
| K = | −0.47716E+02 |
| A3 = | −0.25021E+00 |
| A4 = | −0.61286E+00 |
| A5 = | −0.59333E+00 |
| A6 = | −0.74663E+01 |
| A7 = | 0.00000E+00 |
| A8 = | 0.17927E+02 |
| A9 = | 0.00000E+00 |
| A10 = | −0.95061E+02 |
| A11 = | 0.00000E+00 |
| A12 = | −0.15245E+03 |
| A13 = | 0.00000E+00 |
| A14 = | −0.68944E+03 |
| A15 = | 0.00000E+00 |
| A16 = | −0.35128E+03 |
| A17 = | 0.00000E+00 |
| A18 = | 0.22863E+05 |
| A19 = | 0.00000E+00 |
| A20 = | 0.19010E+06 |

10th surface

| | |
|---|---|
| K = | −0.50000E+02 |
| A3 = | −0.32327E−01 |
| A4 = | −0.35511E+00 |
| A5 = | 0.32713E+00 |
| A6 = | −0.22725E+01 |
| A7 = | 0.00000E+00 |
| A8 = | 0.71773E+01 |
| A9 = | 0.00000E+00 |
| A10 = | −0.11355E+02 |
| A11 = | 0.00000E+00 |
| A12 = | 0.73792E+01 |
| A13 = | 0.00000E+00 |
| A14 = | 0.11857E+02 |
| A15 = | 0.00000E+00 |
| A16 = | 0.89891E+02 |
| A17 = | 0.00000E+00 |
| A18 = | 0.27947E+03 |
| A19 = | 0.00000E+00 |
| A20 = | −0.52246E+03 |

Followings are numerical values of Expressions (1) to (6) and (9) to (12) in the imaging optical system of the second example.

d12/f=0.80 Expression (1):

f1/f3=1.00 Expression (2):

ν1=23.9 Expression (3):

d1/f=0.26 Expression (4):

f1/f=−1.00 Expression (5):

(r1+r2)/(r1−r2)=2.44 Expression (6):

f2/f=0.56 Expression (9):

f3/f=−1.00 Expression (10):

(r3+r4)/(r3−r4)=0.37 Expression (11):

(r5+r6)/(r5−r6)=0.21 Expression (12):

### Third Example

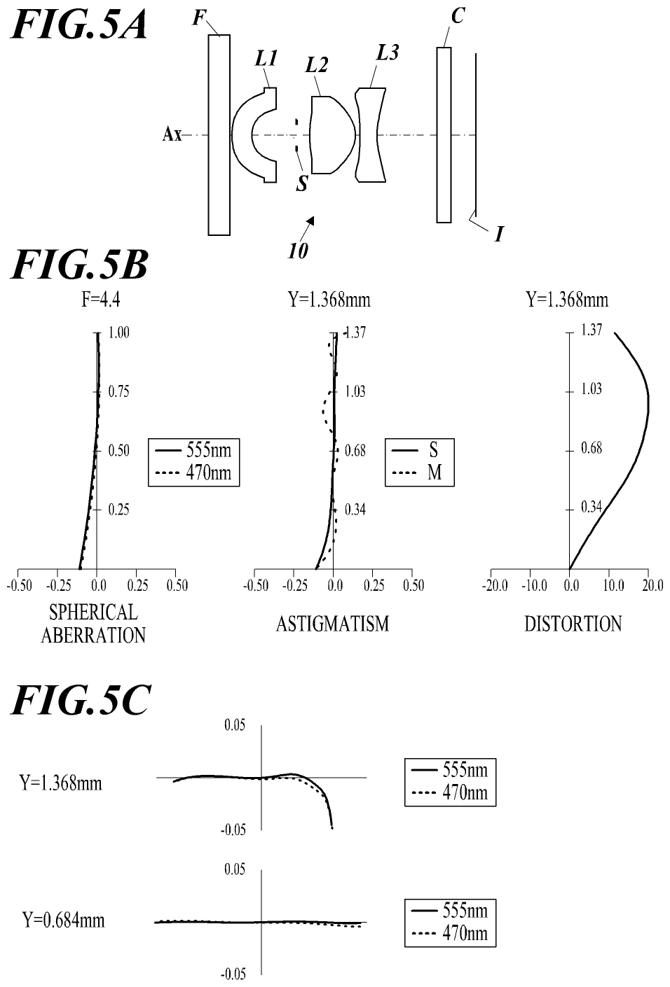

FIG. 5A is a cross-sectional view of an imaging optical system in a third example. FIG. 5B shows longitudinal aberration diagrams (spherical aberration, astigmatism, and distortion) in the third example. FIG. 5C shows meridional lateral aberration diagrams in the third example.

Followings are specifications of the imaging optical system in the third example.

f=1.014 mm

F=4.4

2Y=2.736 mm

2ω=93.9°

The following table 5 shows data of the lens surfaces in the third example.

TABLE 5

| Surface | | | | | Effective |
|---|---|---|---|---|---|
| number | R(mm) | D(mm) | Nd | ν d | radius(mm) |
| OBJ | ∞ | 10.0 | | | |
| 1 | ∞ | 0.30 | 1.5163 | 64.1 | 1.29 |
| 2 | ∞ | 0.03 | | | 1.13 |
| 3* | 1.154 | 0.28 | 1.6347 | 23.9 | 0.61 |
| 4* | 0.486 | 0.63 | | | 0.37 |
| 5(Stop) | ∞ | 0.02 | | | 0.16 |
| 6(Stop) | ∞ | 0.17 | | | 0.16 |
| 7* | 1.563 | 0.65 | 1.5434 | 56.1 | 0.34 |
| 8* | −0.383 | 0.06 | | | 0.50 |
| 9* | −3.152 | 0.24 | 1.6347 | 23.9 | 0.54 |
| 10* | 0.999 | 0.85 | | | 0.61 |
| 11 | ∞ | 0.20 | 1.5163 | 64.1 | 1.05 |
| 12 | ∞ | 0.35 | | | 1.13 |
| 13 | ∞ | | | | 1.37 |

The following table 6 shows aspheric coefficients of the lens surfaces in the third example.

TABLE 6
3rd surface

| | |
|---|---|
| K = | 0.99242E+00 |
| A3 = | 0.25309E+00 |
| A4 = | 0.17396E+01 |
| A5 = | 0.52840E+00 |
| A6 = | −0.79362E+01 |
| A7 = | 0.00000E+00 |
| A8 = | 0.35327E+02 |
| A9 = | 0.00000E+00 |
| A10 = | −0.72644E+02 |
| A11 = | 0.00000E+00 |
| A12 = | −0.45224E+01 |
| A13 = | 0.00000E+00 |
| A14 = | 0.25725E+03 |
| A15 = | 0.00000E+00 |
| A16 = | −0.32065E+02 |
| A17 = | 0.00000E+00 |
| A18 = | 0.12730E+04 |
| A19 = | 0.00000E+00 |
| A20 = | −0.44833E+04 |

4th surface

| | |
|---|---|
| K = | −0.13038E+01 |
| A3 = | 0.35918E+00 |
| A4 = | 0.62743E+01 |
| A5 = | 0.51143E+01 |
| A6 = | −0.19634E+02 |
| A7 = | 0.00000E+00 |
| A8 = | −0.24365E+03 |
| A9 = | 0.00000E+00 |
| A10 = | 0.83390E+04 |
| A1l = | 0.00000E+00 |
| A12 = | −0.34948E+05 |
| A13 = | 0.00000E+00 |
| A14 = | −0.47579E+06 |
| A15 = | 0.00000E+00 |
| A16 = | 0.39603E+07 |
| A17 = | 0.00000E+00 |
| A18 = | 0.10207E+09 |
| A19 = | 0.00000E+00 |
| A20 = | −0.10295E+09 |

7th surface

| | |
|---|---|
| K = | −0.15543E+02 |
| A3 = | −0.47511E−01 |
| A4 = | −0.41297E−01 |
| A5 = | −0.82062E+00 |
| A6 = | 0.91345E+01 |
| A7 = | 0.00000E+00 |
| A8 = | −0.13727E+03 |
| A9 = | 0.00000E+00 |
| A10 = | 0.12402E+04 |
| A11 = | 0.00000E+00 |
| A12 = | −0.52146E+04 |
| A13 = | 0.00000E+00 |
| A14 = | 0.49658E+04 |
| A15 = | 0.00000E+00 |
| A16 = | 0.93715E+05 |
| A17 = | 0.00000E+00 |
| A18 = | −0.15326E+07 |
| A19 = | 0.00000E+00 |
| A20 = | 0.46716E+07 |

8th surface

| | |
|---|---|
| K = | −0.70335E+00 |
| A3 = | 0.38558E+00 |
| A4 = | 0.13903E+01 |
| A5 = | 0.35188E+00 |
| A6 = | −0.84464E+01 |
| A7 = | 0.00000E+00 |
| A8 = | 0.28293E+02 |
| A9 = | 0.00000E+00 |
| A10 = | −0.10690E+02 |
| A11 = | 0.00000E+00 |
| A12 = | −0.13277E−03 |
| A13 = | 0.00000E+00 |
| A14 = | 0.28147E+03 |
| A15 = | 0.00000E+00 |
| A16 = | 0.13525E+04 |
| A17 = | 0.00000E+00 |
| A18 = | −0.26765E+04 |
| A19 = | 0.00000E+00 |
| A20 = | −0.12416E+05 |

9th surface

| | |
|---|---|
| K = | −0.30542E+02 |
| A3 = | 0.18945E+00 |
| A4 = | −0.38666E+00 |
| A5 = | 0.50701E+00 |
| A6 = | −0.61025E+01 |
| A7 = | 0.00000E+00 |
| A8 = | 0.21981E+02 |
| A9 = | 0.00000E+00 |
| A10 = | −0.49596E+02 |
| A11 = | 0.00000E+00 |
| A12 = | 0.91112E+02 |
| A13 = | 0.00000E+00 |
| A14 = | 0.55537E+02 |
| A15 = | 0.00000E+00 |
| A16 = | −0.39211E+03 |
| A17 = | 0.00000E+00 |
| A18 = | 0.35352E+03 |
| A19 = | 0.00000E+00 |
| A20 = | −0.38828E+01 |

10th surface

| | |
|---|---|
| K = | −0.19331E+02 |
| A3 = | 0.18105E+00 |
| A4 = | −0.27111E−01 |
| A5 = | 0.18135E+00 |
| A6 = | −0.25305E+01 |
| A7 = | 0.00000E+00 |
| A8 = | 0.74305E+01 |
| A9 = | 0.00000E+00 |
| A10 = | −0.10149E+02 |
| A11 = | 0.00000E+00 |
| A12 = | 0.65634E+01 |
| A13 = | 0.00000E+00 |
| A14 = | −0.31788E+01 |
| A15 = | 0.00000E+00 |
| A16 = | −0.20515E+01 |
| A17 = | 0.00000E+00 |
| A18 = | 0.35538E+01 |
| A19 = | 0.00000E+00 |
| A20 = | 0.85548E+02 |

Followings are numerical values of Expressions (1) to (6) and (9) to (12) in the imaging optical system of the third example.

d12/f=0.81 Expression (1):

f1/f3=1.35 Expression (2):

ν1=23.9 Expression (3):

d1/f=0.28 Expression (4):

f1/f=−1.55 Expression (5):

(r1+r2)/(r1−r2)=2.45 Expression (6):

f2/f=0.63 Expression (9):

f3/f=−1.14 Expression (10):

(r3+r4)/(r3−r4)=0.61 Expression (11):

(r5+r6)/(r5−r6)=0.52 Expression (12):

### Fourth Example

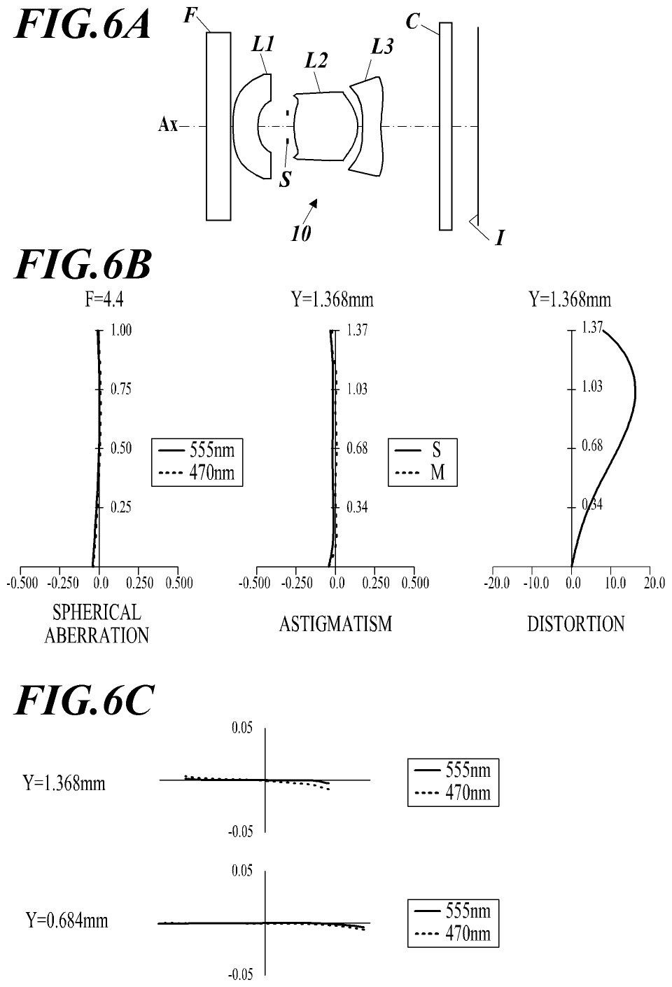

FIG. 6A is a cross-sectional view of an imaging optical system in a fourth example. FIG. 6B shows longitudinal aberration diagrams (spherical aberration, astigmatism, and distortion) of the fourth example. FIG. 6C shows meridional lateral aberration diagrams of the fourth example.

Followings are specifications of the imaging optical system in the fourth example.

f=1.083 mm

F=4.4

2Y=2.736 mm

2ω=93.8°

The following table 7 shows data of the lens surfaces in the fourth example.

TABLE 7

| Surface | | | | | Effective |
|---|---|---|---|---|---|
| number | R(mm) | D(mm) | Nd | ν d | radius(mm) |
| OBJ | ∞ | 10.0 | | | |
| 1 | ∞ | 0.30 | 1.5163 | 64.1 | 1.07 |
| 2 | ∞ | 0.03 | | | 0.91 |
| 3* | 3.335 | 0.31 | 1.5830 | 30.0 | 0.59 |
| 4* | 0.706 | 0.37 | | | 0.33 |
| 5(Stop) | ∞ | 0.02 | | | 0.16 |
| 6(Stop) | ∞ | 0.06 | | | 0.16 |
| 7* | 0.990 | 0.80 | 1.5434 | 56.1 | 0.23 |
| 8* | −0.454 | 0.06 | | | 0.45 |
| 9* | −5.220 | 0.23 | 1.6610 | 20.5 | 0.50 |
| 10* | 1.362 | 0.74 | | | 0.69 |
| 11 | ∞ | 0.15 | 1.5163 | 64.1 | 1.13 |
| 12 | ∞ | 0.33 | | | 1.18 |
| 13 | ∞ | | | | 1.37 |

The following table 8 shows aspheric coefficients of the lens surfaces in the fourth example.

TABLE 8
3rd surface

| | |
|---|---|
| K = | 0.17948E+01 |
| A3 = | 0.12582E−02 |
| A4 = | 0.25154E+01 |
| A5 = | 0.23187E+00 |
| A6 = | −0.96104E+01 |
| A7 = | 0.00000E+00 |
| A8 = | 0.36585E+02 |
| A9 = | 0.00000E+00 |
| A10 = | −0.65477E+02 |
| A11 = | 0.00000E+00 |
| A12 = | −0.42101E411 |
| A13 = | 0.00000E+00 |
| A14 = | 0.21649E+03 |
| A15 = | 0.00000E+00 |
| A16 = | −0.25332E+03 |
| A17 = | 0.00000E+00 |
| A18 = | 0.60519E+03 |
| A19 = | 0.00000E+00 |
| A20 = | −0.12242E+04 |

4th surface

| | |
|---|---|
| K = | −0.15823E+01 |
| A3 = | 0.15252E−01 |
| A4 = | 0.62578E+01 |
| A5 = | 0.36033E+01 |
| A6 = | −0.22180E+02 |
| A7 = | 0.00000E+00 |
| A8 = | −0.10038E+03 |
| A9 = | 0.0000−E+00 |
| A10 = | 0.76645E+04 |
| A11 = | 0.00000E+00 |
| A12 = | −0.43306E+05 |
| A13 = | 0.00000E+00 |
| A14 = | −0.47167E+06 |
| A15 = | 0.00000E+00 |
| A16 = | 0.49465E+07 |
| A17 = | 0.00000E+00 |
| A18 = | 0.16622E+08 |
| A18 = | 0.00000E+00 |
| A20 = | −0.18555E+09 |

7th surface

| | |
|---|---|
| K = | −0.15084E+01 |
| A3 = | −0.26356E−01 |
| A4 = | 0.64560E+00 |
| A5 = | 0.23470E−01 |
| A6 = | 0.55644E+01 |
| A7 = | 0.00000E+00 |
| A8 = | −0.15793E+03 |
| A9 = | 0.00000E+00 |
| A10 = | 0.19051E+04 |
| A11 = | 0.00000E+00 |
| A12 = | 0.97891E+03 |
| A13 = | 0.00000E+00 |
| A14 = | −0.16400E+05 |
| A15 = | 0.00000E+00 |
| A16 = | −0.10916E+07 |
| A17 = | 0.00000E+00 |
| A18 = | −0.12719E+08 |
| A19 = | 0.00000E+00 |
| A20 = | 0.10538E+09 |

8th surface

| | |
|---|---|
| K = | −0.73526E+00 |
| A3 = | −0.13837E+00 |
| A4 = | 0.10450E+01 |
| A5 = | 0.10128E+01 |
| A6 = | −0.64478E+01 |
| A7 = | 0.00000E+00 |
| A8 = | 0.31125E+02 |
| A9 = | 0.00000E+00 |
| A10 = | −0.21437E+02 |
| A11 = | 0.00000E+00 |
| A12 = | −0.12963E+03 |
| A13 = | 0.00000E+00 |
| A14 = | 0.35487E+03 |
| A15 = | 0.00000E+00 |
| A16 = | 0.24353E+04 |
| A17 = | 0.00000E+00 |
| A18 = | 0.33900E+04 |
| A19 = | 0.00000E+00 |
| A20 = | −0.44546E+04 |

9th surface

| | |
|---|---|
| K = | −0.39435E+02 |
| A3 = | −0.32645E+00 |
| A4 = | −0.61426E+00 |
| A5 = | 0.72840E−01 |
| A6 = | 0.69426E+01 |
| A7 = | 0.00000E+00 |
| A8 = | 0.17390E+02 |
| A9 = | 0.00000E+00 |
| A10 = | −0.59457E−02 |
| A11 = | 0.00000E+00 |
| A12 = | 0.90017E+02 |
| A13 = | 0.00000E+00 |
| A14 = | 0.14777E+03 |
| A15 = | 0.00000E+00 |
| A16 = | 0.10205E+03 |
| A17 = | 0.00000E+00 |
| A18 = | 0.20163E+04 |
| A19 = | 0.00000E+00 |
| A20 = | 0.38190E−01 |

10th surface

| | |
|---|---|
| K = | −0.30348E+02 |
| A3 = | −0.39718E−02 |
| A4 = | −0.38449E+00 |
| A5 = | −0.30560E−02 |
| A6 = | −0.24464E+01 |
| A7 = | 0.00000E+00 |
| A8 = | 0.76092E+01 |
| A9 = | 0.00000E+00 |
| A10 = | −0.10448E+02 |
| A11 = | 0.00000E+00 |
| A12 = | 0.59976E+01 |
| A13 = | 0.00000E+00 |
| A14 = | −0.22305E+01 |
| A15 = | 0.00000E+00 |
| A16 = | 0.29924E+01 |
| A17 = | 0.00000E+00 |
| A18 = | 0.33808E+01 |
| A19 = | 0.00000E+00 |
| A20 = | −0.54746E+01 |

Followings are numerical values of Expressions (1) to (6) and (9) to (12) in the imaging optical system of the fourth example.

d12/f=0.42 Expression (1):

f1/f3=1.00 Expression (2):

ν1=30.2 Expression (3):

d1/f=0.29 Expression (4):

f1/f=−1.48 Expression (5):

(r1+r2)/(r1−r2)=1.54 Expression (6):

f2/f=0.65 Expression (9):

f3/f=−1.48 Expression (10):

(r3+r4)/(r3−r4)=0.37 Expression (11):

(r5+r6)/(r5−r6)=0.59 Expression (12):

### Fifth Example

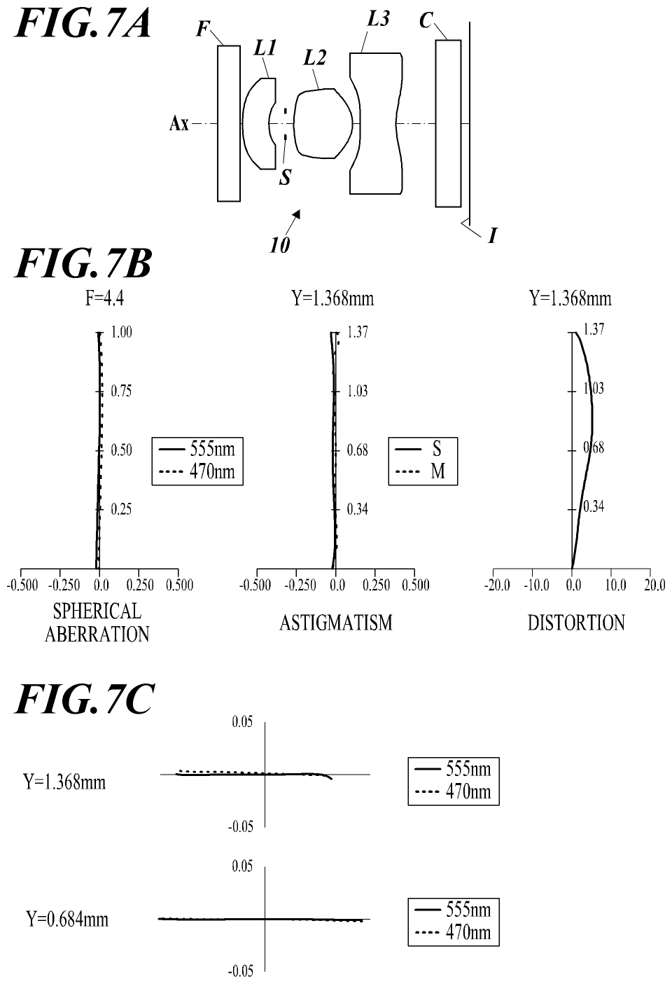

FIG. 7A is a cross-sectional view of an imaging optical system in a fifth example. FIG. 7B shows longitudinal aberration diagrams (spherical aberration, astigmatism, and distortion) of the fifth example. FIG. 7C shows meridional lateral aberration diagrams of the fifth example.

Followings are specifications of the imaging optical system in the fifth example.

f=1.151 mm

F=4.4

2Y=2.736 mm

2ω=93.9°

The following table 9 shows data of the lens surfaces in the fifth example.

TABLE 9

| Surface | | | | | Effective |
|---|---|---|---|---|---|
| number | R(mm) | D(mm) | Nd | ν d | radius(mm) |
| OBJ | ∞ | 10.0 | | | |
| 1 | ∞ | 0.30 | 1.5163 | 64.1 | 0.93 |
| 2 | ∞ | 0.03 | | | 0.77 |
| 3* | 1.681 | 0.35 | 1.6610 | 20.5 | 0.54 |
| 4* | 0.693 | 0.22 | | | 0.28 |
| 5(Stop) | ∞ | 0.02 | | | 0.15 |
| 6(Stop) | ∞ | 0.09 | | | 0.15 |
| 7* | 1.448 | 0.78 | 1.5434 | 56.1 | 0.30 |
| 8* | −0.387 | 0.10 | | | 0.50 |
| 9* | −2.655 | 0.47 | 1.6610 | 20.5 | 0.58 |
| 10* | 1.063 | 0.52 | | | 0.84 |
| 11 | ∞ | 0.33 | 1.5163 | 64.1 | 1.15 |
| 12 | ∞ | 0.11 | | | 1.29 |
| 13 | ∞ | | | | 1.37 |

The following table 10 shows aspheric coefficients of the lens surfaces in the fifth example.

TABLE 10
3rd surface

| | |
|---|---|
| K = | −0.50000E+02 |
| A3 = | 0.15783E−01 |
| A4 = | 0.22290E+01 |
| A5 = | 0.57118E+00 |
| A6 = | −0.93855E+01 |
| A7 = | 0.00000E+00 |
| A8 = | 0.34584E+02 |
| A9 = | 0.00000E+00 |
| A10 = | −0.65536E+02 |
| A11 = | 0.00000E+00 |
| A12 = | 0.63847E+01 |
| A13 = | 0.00000E+00 |
| A14 = | 0.23177E+03 |
| A15 = | 0.00000E+00 |
| A16 = | −0.29789E+03 |
| A17 = | 0.00000E+00 |
| A18 = | 0.40110E+03 |
| A19 = | 0.00000E+00 |
| A20 = | −0.14103E+04 |

4th surface

| | |
|---|---|
| K = | −0.60658E+01 |
| A3 = | 0.26773E−01 |
| A4 = | 0.59204E+01 |
| A5 = | 0.36122E+01 |
| A6 = | −0.20621E+02 |
| A7 = | 0.00000E+00 |
| A8 = | −0.95681E+02 |
| A9 = | 0.00000E+00 |
| A10 = | 0.72912E+04 |
| A11 = | 0.00000E+00 |
| A12 = | −0.45595E+05 |
| A13 = | 0.00000E+00 |
| A14 = | −0.44481E+06 |
| A15 = | 0.00000E+00 |
| A16 = | 0.53732E+07 |
| A17 = | 0.00000E+00 |
| A18 = | 0.14709E+08 |
| A19 = | 0.00000E+00 |
| A20 = | −0.33783E+09 |

7th surface

| | |
|---|---|
| K = | −0.15865E+02 |
| A3 = | 0.79037E−01 |
| A4 = | 0.85035E−01 |
| A5 = | −0.12282E−01 |
| A6 = | 0.11962E+02 |
| A7 = | 0.00000E+00 |
| A8 = | −0.11716E+03 |
| A9 = | 0.00000E+00 |
| A10 = | 0.11663E+04 |
| A11 = | 0.00000E+00 |
| A12 = | −0.70551E+04 |
| A13 = | 0.00000E+00 |
| A14 = | −0.71998E−04 |
| A15 = | 0.00000E+00 |
| A16 = | 0.20433E+06 |
| A17 = | 0.00000E−00 |
| A18 = | −0.24243E+06 |
| A19 = | 0.00000E+00 |
| A20 = | 0.77957E+06 |

8th surface

| | |
|---|---|
| K = | −0.74081E+00 |
| A3 = | 0.23758E+00 |
| A4 = | 0.11126E+01 |
| A5 = | 0.41390E+00 |
| A6 = | −0.80091E+01 |
| A7 = | 0.00000E+00 |
| A8 = | 0.31226E+02 |
| A9 = | 0.00000E+00 |
| A10 = | −0.18940E+02 |
| A11 = | 0.00000E+00 |
| A12 = | −0.10855E+03 |
| A13 = | 0.00000E+00 |
| A14 = | 0.36826E+03 |
| A15 = | 0.00000E+00 |
| A16 = | 0.19412E+04 |
| A17 = | 0.00000E+00 |
| A18 = | −0.50164E+03 |
| A19 = | 0.00000E+00 |
| A20 = | −0.15232E+05 |

9th surface

| | |
|---|---|
| K = | 0.50000E+02 |
| A3 = | 0.15757E+00 |
| A4 = | −0.34504E+00 |
| A5 = | −0.59559E−01 |
| A6 = | −0.69505E+01 |
| A7 = | 0.00000E+00 |
| A8 = | 0.22423E+02 |
| A9 = | 0.00000E+00 |
| A10 = | −0.43764E+02 |
| A11 = | 0.00000E+00 |
| A12 = | 0.99785E+02 |
| A13 = | 0.00000E+00 |
| A14 = | 0.64415E+02 |
| A15 = | 0.00000E+00 |
| A16 = | −0.48641E+03 |
| A17 = | 0.00000E+00 |
| A18 = | −0.66373E+02 |
| A19 = | 0.00000E+00 |
| A20 = | 0.65079E+03 |

10th surface

| | |
|---|---|
| K = | −0.17050E+02 |
| A3 = | 0.14277E+00 |
| A4 = | −0.10133E+00 |
| A5 = | 0.13309E+00 |
| A6 = | −0.26135E+01 |
| A7 = | 0.00000E+00 |
| A8 = | 0.73547E+01 |
| A9 = | 0.00000E+00 |
| A10 = | −0.10048E+02 |
| A11 = | 0.00000E+00 |
| A12 = | 0.67682E+01 |
| A13 = | 0.00000E+00 |
| A14 = | −0.20584E+01 |
| A15 = | 0.00000E+00 |
| A16 = | 0.10287E+01 |
| A17 = | 0.00000E+00 |
| A18 = | 0.10591E+00 |
| A19 = | 0.00000E+00 |
| A20 = | −0.10980E+01 |

Followings are numerical values of Expressions (1) to (6) and (9) to (12) in the imaging optical system of the fifth example.

d12/f=0.29 Expression (1):

f1/f3=1.90 Expression (2):

ν1=20.5 Expression (3):

d1/f=0.3 Expression (4):

f1/f=−1.79 Expression (5):

(r1+r2)/(r1−r2)=2.40 Expression (6):

f2/f=0.57 Expression (9):

f3/f=−0.94 Expression (10):

(r3+r4)/(r3−r4)=0.58 Expression (11):

(r5+r6)/(r5−r6)=0.43 Expression (12):

### Sixth Example

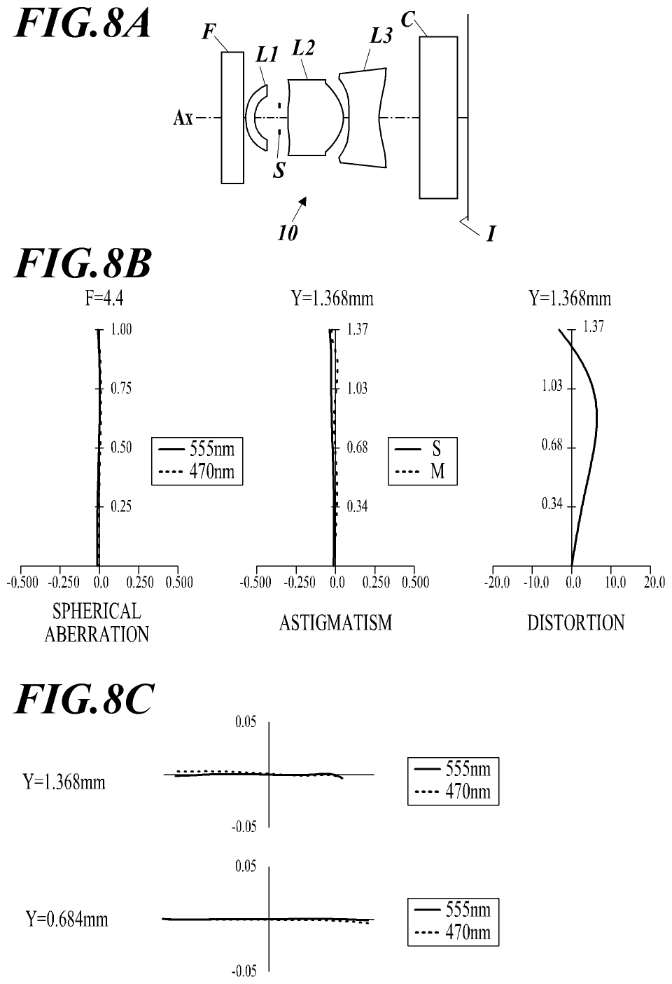

FIG. 8A is a cross-sectional view of an imaging optical system in a sixth example. FIG. 8B shows longitudinal aberration diagrams (spherical aberration, astigmatism, and distortion) of the sixth example. FIG. 8C shows meridional lateral aberration diagrams of the sixth example.

Followings are specifications of the imaging optical system in the sixth example.

f=1.211 mm

F=4.4

2Y=2.736 mm

2ω=93.8°

The following table 11 shows data of the lens surfaces in the sixth example.

TABLE 11

| Surface | | | | | Effective |
|---|---|---|---|---|---|
| number | R(mm) | D(mm) | Nd | νd | radius(mm) |
| OBJ | ∞ | 10.0 | | | |
| 1 | ∞ | 0.30 | 1.5163 | 64.1 | 0.81 |
| 2 | ∞ | 0.03 | | | 0.65 |
| 3* | 0.774 | 0.12 | 1.6347 | 23.9 | 0.40 |
| 4* | 0.465 | 0.33 | | | 0.30 |
| 5(Stop) | ∞ | 0.02 | | | 0.16 |
| 6(Stop) | ∞ | 0.09 | | | 0.16 |
| 7* | 1.408 | 0.76 | 1.5434 | 56.1 | 0.28 |
| 8* | −0.416 | 0.08 | | | 0.47 |
| 9* | −3.209 | 0.41 | 1.6347 | 23.9 | 0.50 |
| 10* | 1.000 | 0.55 | | | 0.73 |
| 11 | ∞ | 0.51 | 1.5163 | 64.1 | 1.05 |
| 12 | ∞ | 0.14 | | | 1.26 |
| 13 | ∞ | | | | 1.37 |

The following table 12 shows aspheric coefficients of the lens surfaces in the sixth example.

TABLE 12
3rd surface

| | |
|---|---|
| K = | 0.13606E+01 |
| A3 = | 0.80727E−01 |
| A4 = | 0.28103E+01 |
| A5 = | 0.58706E+00 |
| A6 = | −0.86628E+01 |
| A7 = | 0.00000E+00 |
| A8 = | 0.41078E+02 |
| A9 = | 0.00000E+00 |
| A10 = | −0.52374E+02 |
| A11 = | 0.00000E−00 |
| A12 = | −0.48839E+02 |
| A13 = | 0.00000E+00 |
| A14 = | −0.69045E+03 |
| A15 = | 0.00000E+00 |
| A16 = | −0.64537E+04 |
| A17 = | 0.00000E+00 |
| A18 = | −0.14240E+05 |
| A19 = | 0.00000E+00 |
| A20 = | 0.21498E+06 |

4th surface

| | |
|---|---|
| K = | −0.55239E+00 |
| A3 = | −0.34391E−01 |
| A4 = | 0.66714E+01 |
| A5 = | 0.42583E+01 |
| At3 = | −0.17407E+02 |
| A7 = | 0.00000E+00 |
| A8 = | −0.37833E+02 |
| A9 = | 0.00000E+00 |
| A10 = | 0.77365E+04 |
| A11 = | 0.00000E+00 |
| A12 = | −0.45098E+05 |
| A13 = | 0.00000E+00 |
| A14 = | −0.48719E+06 |
| A15 = | 0.00000E+00 |
| A16 = | 0.47297E+07 |
| A17 = | 0.00000E+00 |
| A18 = | 0.37461E+07 |
| A19 = | 0.00000E+00 |
| A20 = | −0.45244E+08 |

7th surface

| | |
|---|---|
| K = | −0.13589E+02 |
| A3 = | 0.51998E−01 |
| A4 = | 0.42166E−01 |
| A5 = | −0.22109E+00 |
| A6 = | 0.92268E+01 |
| A7 = | 0.00000E+00 |
| A8 = | −0.15038E+03 |
| A9 = | 0.00000E+00 |
| A10 = | 0.13069E+04 |
| A11 = | 0.00000E+00 |
| A12 = | −0.41354E+04 |
| A13 = | 0.00000E+00 |
| A14 = | 0.11326E+05 |
| A15 = | 0.00000E+00 |
| A15 = | 0.72713E+05 |
| A17 = | 0.00000E+00 |
| A18 = | −0.15590E+07 |
| A19 = | 0.00000E+00 |
| A20 = | −0.15554E+07 |

8th surface

| | |
|---|---|
| K = | −0.72769E+00 |
| A3 = | 0.10613E+00 |
| A4 = | 0.82354E+00 |
| A5 = | 0.16026E+00 |
| A6 = | −0.71041E+01 |
| A7 = | 0.00000E+00 |
| A8 = | 0.32254E+02 |
| A9 = | 0.00000E+00 |
| A10 = | −0.23131E+02 |
| A11 = | 0.00000E+00 |
| A12 = | −0.16467E+03 |
| A13 = | 0.00000E+00 |
| A14 = | 0.15276E+03 |
| A15 = | 0.00000E+00 |
| A16 = | 0.15807E+04 |
| A17 = | 0.00000E+00 |
| A18 = | 0.21854E+03 |
| A19 = | 0.00000E+00 |
| A20 = | −0.37544E+04 |

9th surface

| | |
|---|---|
| K = | −0.82246E+01 |
| A3 = | 0.39536E−01 |
| A4 = | −0.56490E+00 |
| A5 = | 0.95703E−01 |
| A6 = | −0.70228E+01 |
| A7 = | 0.00000E+00 |
| A8 = | 0.20946E+02 |
| A9 = | 0.00000E+00 |
| A10 = | −0.46844E+02 |
| A11 = | 0.00000E+00 |
| A12 = | 0.98213E+02 |
| A13 = | 0.00000E+00 |
| A14 = | 0.61235E+02 |
| A15 = | 0.00000E+00 |
| A16 = | −0.41877E+03 |
| A17 = | 0.00000E+00 |
| A18 = | 0.88838E+02 |
| A19 = | 0.00000E+00 |
| A20 = | 0.22912E+04 |

10th surface

| | |
|---|---|
| K = | −0.10849E+02 |
| A3 = | 0.52744E−01 |
| A4 = | 0.30368E−01 |
| A5 = | 0.47909E−01 |
| A6 = | −0.26290E+01 |
| A7 = | 0.00000E+00 |
| A8 = | 0.74497E+01 |
| A9 = | 0.00000E+00 |
| A10 = | −0.10136E+02 |
| A11 = | 0.00000E+00 |
| A12 = | 0.66535E+01 |
| A13 = | 0.00000E+00 |
| A14 = | −0.21247E+01 |
| A15 = | 0.00000E+00 |
| A16 = | 0.12464E+01 |
| A17 = | 0.00000E+00 |
| A18 = | 0.31571E+00 |
| A19 = | 0.00000E+00 |
| A20 = | −0.64300E+00 |

Followings are numerical values of Expressions (1) to (6) and (9) to (12) in the imaging optical system of the sixth example.

d12/f=0.37 Expression (1):

f1/f3=1.88 Expression (2):

ν1=23.9 Expression (3):

d1/f=0.10 Expression (4):

f1/f=−1.78 Expression (5):

(r1+r2)/(r1−r2)=4.01 Expression (6):

f2/f=0.57 Expression (9):

f3/f=−0.95 Expression (10):

(r3+r4)/(r3−r4)=0.54 Expression (11):

(r5+r6)/(r5−r6)=0.52 Expression (12):

### Seventh Example

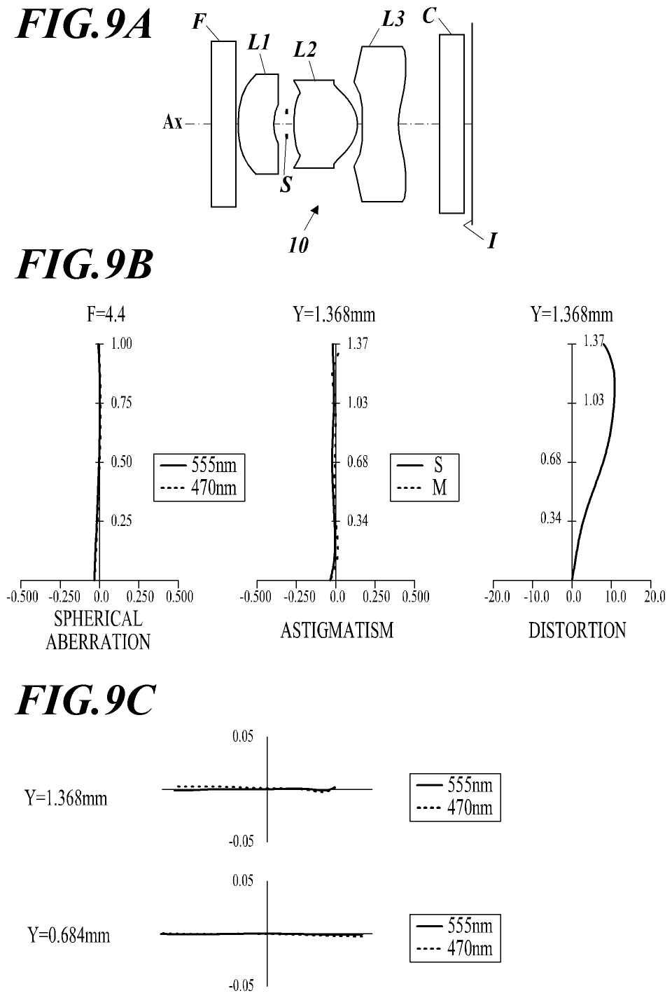

FIG. 9A is a cross-sectional view of an imaging optical system in a seventh example. FIG. 9B shows longitudinal aberration diagrams (spherical aberration, astigmatism, and distortion) of the seventh example. FIG. 9C shows meridional lateral aberration diagrams of the seventh example.

Followings are specifications of the imaging optical system in the seventh example.

f=1.097 mm

F=4.4

2Y=2.736 mm

2ω=92.5°

The following table 13 shows data of the lens surfaces in the seventh example.

TABLE 13

| Surface | | | | | Effective |
|---|---|---|---|---|---|
| number | R(mm) | D(mm) | Nd | νd | radius(mm) |
| OBJ | ∞ | 10.0 | | | |
| 1 | ∞ | 0.30 | 1.6163 | 64.1 | 0.93 |
| 2 | ∞ | 0.03 | | | 0.77 |
| 3* | 1.722 | 0.44 | 1.6347 | 23.9 | 0.56 |
| 4* | 0.710 | 0.15 | | | 0.24 |
| 5(Stop) | ∞ | 0.02 | | | 0.13 |
| 6(Stop) | ∞ | 0.08 | | | 0.13 |
| 7* | 1.433 | 0.78 | 1.5434 | 56.1 | 0.29 |
| 8* | −0.385 | 0.06 | | | 0.49 |
| 9* | −6.589 | 0.44 | 1.6347 | 23.9 | 0.57 |
| 10* | 0.933 | 0.51 | | | 0.87 |
| 11 | ∞ | 0.30 | 1.5163 | 64.1 | 1.17 |
| 12 | ∞ | 0.10 | | | 1.30 |
| 13 | ∞ | | | | 1.37 |

The following table 14 shows aspheric coefficients of the lens surfaces in the seventh example.

TABLE 14
3rd surface

| | |
|---|---|
| K = | −0.46509E+02 |
| A3 = | −0.80945E−01 |
| A4 = | 0.23329E+01 |
| A5 = | 0.12517E+00 |
| A6 = | −0.94177E+01 |
| A7 = | 0.00000E+00 |
| A8 = | 0.36408E+02 |
| A9 = | 0.00000E+00 |
| A10 = | −0.68031E+02 |
| A11 = | 0.00000E+00 |
| A12 = | −0.82553E+01 |
| A13 = | 0.00000E+00 |
| A14 = | 0.21905E+03 |
| A15 = | 0.00000E+00 |
| A16 = | −0.22739E+03 |
| A17 = | 0.00000E+00 |
| A18 = | 0.63537E103 |
| A19 = | 0.00000E+00 |
| A20 = | 0.16893E+04 |

4th surface

| | |
|---|---|
| K = | −0.60115E+01 |
| A3 = | 0.46552E−02 |
| A4 = | 0.58935E+01 |
| A5 = | 0.16988E+01 |
| A6 = | −0.20363E+02 |
| A7 = | 0.00000E+00 |
| A8 = | 0.14654E+02 |
| A9 = | 0.00000E+00 |
| A10 = | 0.72826E+04 |
| A11 = | 0.00000E+00 |
| A12 = | −0.57039E+05 |
| A13 = | 0.00000E+00 |
| A14 = | −0.55755E+05 |
| A15 = | 0.00000E+00 |
| A16 = | 0.53849E+07 |
| A17 = | 0.00000E+00 |
| A18 = | 0.21137E+08 |
| A19 = | 0.00000E+00 |
| A20 = | −0.79979E+09 |

7th surface

| | |
|---|---|
| K = | +0.13489E+02 |
| A3 = | 0.38887E+01 |
| A4 = | 0.17040E+00 |
| A5 = | 0.49202E+00 |
| A6 = | 0.11762E+02 |
| A7 = | 0.00000E+00 |
| A8 = | −0.13784E+03 |
| A9 = | 0.00000E+00 |
| A10 = | 0.12766E+04 |
| A11 = | 0.00600E+00 |
| A12 = | −0.51842E+04 |
| A13 = | 0.00000E+00 |
| A14 = | −−0.11459E+04 |
| A15 = | 0.00000E+00 |
| A16 = | −0.34752E+05 |
| A17 = | 0.00000E+00 |
| A18 = | −0.15538E+07 |
| A19 = | 0.00000E+00 |
| A20 = | 0.15810E+08 |

8th surface

| | |
|---|---|
| K = | 0.72302E+00 |
| A3 = | 0.92067E−01 |
| A4 = | 0.80787E+00 |
| A5 = | 0.27736E+00 |
| A6 = | −0.69539E+01 |
| A7 = | 0.00000E+00 |
| A8 = | 0.32832E+02 |
| A9 = | 0.00000E+00 |
| A10 = | −0.17742E+02 |
| A11 = | 0.00000E+00 |
| A12 = | −0.13608E+03 |
| A13 = | 0.00000E+00 |
| A14 = | 0.25644E+03 |
| A15 = | 0.00000E+00 |
| A16 = | 0.18472E+04 |
| A17 = | 0.00000E+00 |
| A18 = | 0.61701E+03 |
| A19 = | 0.00000E+00 |
| A20 = | −0.35456E+04 |

9th surface

| | |
|---|---|
| K = | −0.12077E+02 |
| A3 = | −0.30122E−01 |
| A4 = | −0.49966E+00 |
| A5 = | 0.16572E+00 |
| A6 = | −0.68113E+01 |
| A7 = | 0.00000E+00 |
| A8 = | 0.21628E+02 |
| A9 = | 0.00000E+00 |
| A10 = | −0.45553E+02 |
| A11 = | 0.00000E+00 |
| A12 = | 0.99758E+02 |
| A13 = | 0.00000E+00 |
| A14 = | 0.57992E+02 |
| A15 = | 0.00000E+00 |
| A16 = | −0.37864E+03 |
| A17 = | 0.00008E400 |
| A18 = | −0.20637E+02 |
| A19 = | 0.00000E+00 |
| A20 = | 0.31194E+03 |

10th surface

| | |
|---|---|
| K = | −0.13614E+02 |
| A3 = | 0.98866E−01 |
| A4 = | −0.28769E−01 |
| A5 = | 0.55275E−01 |
| A6 = | −0.26309E+01 |
| A7 = | 0.00000E+00 |
| A8 = | 0.74627E+01 |
| A9 = | 0.00000E+00 |
| A10 = | −0.10069E+02 |
| A11 = | 0.00000E+00 |
| A12 = | 0.67099E+01 |
| A13 = | 0.00000E+00 |
| A14 = | −0.21878E+01 |
| A15 = | 0.00000E+00 |
| A16 = | 0.99200E+00 |
| A17 = | 0.00000E+00 |
| A18 = | −0.49227E−01 |
| A19 = | 0.00000E+00 |
| A20 = | −0.62279E+00 |

Followings are numerical values of Expressions (1) to (6) and (9) to (12) in the imaging optical system of the seventh example.

d12/f=0.22 Expression (1):

f1/f3=1.82 Expression (2):

ν1=23.9 Expression (3):

d1/f=0.40 Expression (4):

f1/f=−2.07 Expression (5):

(r1+r2)/(r1−r2)=2.40 Expression (6):

f2/f=0.60 Expression (9):

f3/f=−1.14 Expression (10):

(r3+r4)/(r3−r4)=0.58 Expression (11):

(r5+r6)/(r5−r6)=0.75 Expression (12):

Although embodiments of the present invention have been described and illustrated in detail, the disclosed embodiments are made for purposes of illustration and example only and not limitation. The scope of the present invention should be interpreted by terms of the appended claims

What is claimed is:

1. An imaging optical system comprising, in order from an object side:
a meniscus first lens an object-side surface of which is convex and that has negative refractive power;
a stop;
a second lens that has positive refractive power; and
a biconcave third lens, wherein
the imaging optical system satisfies Expression (1):
0.10<d12/f≤0.81
where d12 represents a spatial distance along an optical axis between the first lens and the second lens, and f represents a focal length of the entire imaging optical system.

2. An imaging optical system comprising, in order from an object side:
a meniscus first lens an object-side surface of which is convex and that has negative refractive power;
a stop;
a second lens that has positive refractive power; and
a biconcave third lens, wherein
the imaging optical system satisfies Expression (2):
1.0≤f1/f3≤2.6
where f1 represents a focal length of the first lens, and f3 represents a focal length of the third lens.

3. An imaging optical system comprising, in order from an object side:
a meniscus first lens an object-side surface of which is convex and that has negative refractive power;
a stop;
a second lens that has positive refractive power; and
a biconcave third lens, wherein
the imaging optical system satisfies Expression (3):
20<ν1<35
where ν1 represents an Abbe number of the first lens.

4. An imaging optical system comprising, in order from an object side:
a meniscus first lens an object-side surface of which is convex and that has negative refractive power;
a stop;
a second lens that has positive refractive power; and
a biconcave third lens, wherein
the imaging optical system satisfies Expression (4):
0.1≤d1/f≤0.4
where d1 represents a center thickness of the first lens, and f represents a focal length of the entire imaging optical system.

5. An imaging optical system comprising, in order from an object side:
a meniscus first lens an object-side surface of which is convex and that has negative refractive power;
a stop;
a second lens that has positive refractive power; and
a biconcave third lens, wherein
the imaging optical system satisfies Expression (5):
−2.1<f1/f≤−1.0
where f1 represents a focal length of the first lens, and f represents a focal length of the entire imaging optical system.

6. An imaging optical system comprising, in order from an object side:
a meniscus first lens an object-side surface of which is convex and that has negative refractive power;
a stop;
a second lens that has positive refractive power; and
a biconcave third lens, wherein
the imaging optical system satisfies Expression (6):
1.5<(r1+r2)/(r1−r2)<4.5
where r1 represents a radius of curvature of the object-side surface of the first lens, and r2 represents a radius of curvature of an image-side surface of the first lens.

7. The imaging optical system according to claim 1, further satisfying Expression (2):
1.0≤f1/f3≤2.6
where f1 represents a focal length of the first lens, and f3 represents a focal length of the third lens.

8. The imaging optical system according to claim 1, further satisfying Expression (3):
20<ν1<35
where ν1 represents an Abbe number of the first lens.

9. The imaging optical system according to claim 1, further satisfying Expression (4):
0.1≤d1/f≤0.4
where d1 represents a center thickness of the first lens, and f represents the focal length of the entire imaging optical system.

10. The imaging optical system according to claim 1, further satisfying Expression (5):
−2.1<f1/f≤−1.0
where f1 represents a focal length of the first lens, and f represents the focal length of the entire imaging optical system.

11. The imaging optical system according to claim 1, further satisfying Expression (6):
1.5<(r1+r2)/(r1−r2)<4.5
where r1 represents a radius of curvature of the object-side surface of the first lens, and r2 represents a radius of curvature of an image-side surface of the first lens.

12. The imaging optical system according to claim 1, further satisfying Expression (7):
1.0≤f1/f3≤1.9
where f1 represents a focal length of the first lens, and f3 represents a focal length of the third lens.

13. The imaging optical system according to claim 1, further satisfying Expression (8):
−2.1≤f1/f≤1.55
where f1 represents a focal length of the first lens, and f represents the focal length of the entire imaging optical system.

14. The imaging optical system according to claim 1, wherein the first lens, the second lens, and the third lens are simple lenses.

15. The imaging optical system according to claim 1, further satisfying Expression (9):
0.4<f2/f<0.7
where f2 represents a focal length of the second lens.

16. The imaging optical system according to claim 1, further satisfying Expression (10):
−1.5<f3/f<−0.6
where f3 represents a focal length of the third lens.

17. The imaging optical system according to claim 1, further satisfying Expression (11):
0.3<(r3+r4)/(r3−r4)<0.7
where r3 represents a radius of curvature of an object-side surface of the second lens, and r4 represents a radius of curvature of an image-side surface of the second lens.

18. The imaging optical system according to claim 1, further satisfying Expression (12):
0.2<(r5+r6)/(r5−r6)<0.8
where r5 represents a radius of curvature of an object-side surface of the third lens, and r6 represents a radius of curvature of an image-side surface of the third lens.

19. The imaging optical system according to claim 1, further comprising an optical filter placed closer to the object side than the first lens.

20. A lens unit comprising:
the imaging optical system according to claim 1; and
a lens barrel that holds the imaging optical system.

21. An imaging device comprising:
the lens unit according to claim 20; and
an imaging element that captures an image formed by the imaging optical system.
